(19) United States
(12) Patent Application Publication
(10) Pub. No.: US 2007/0175286 A1
(43) Pub. Date: Aug. 2, 2007

(54) Electric shift transfer case

(75) Inventors: Gary Oliveira, Lake Orion, MI (US); Fredric Harold Tubbs, Grand Blanc, MI (US)

Correspondence Address: Patent Docket Administrator;BorgWarner Inc., 3850 Hamlin Road, Auburn Hills, MI, 48326, US

(73) Assignee: BorgWarner Inc., Auburn Hills, MI (US)

(21) Appl. No.: 11/650,053

(22) Filed: Jan. 5, 2007

Related U.S. Application Data
(60) Provisional application No. 60/762,680, filed on Jan. 27, 2006.

(51) Int. Cl. F16H 61/00; F16H 63/32

(52) U.S. Cl. 74/335; 74/473.37

(57) ABSTRACT

A shift fork restrictor operably disposed in a transfer case for the purpose of allowing the shift motor to transfer energy to the currently existing double wound spring, where the energy is stored until the shift motor sensor indicates that the motor is in the proper range location. When the motor is in the proper range location, the stored energy in the spring is released by the shift fork restrictor releasing the cam allowing for maximum torque and speed to be provided through the secondary rail, cam, and shift fork to complete the requested range shift. This configuration can be used to, among other things, select a high or low range in the transfer case, as well as couple the input and output shafts together, which have different gear ratios.

### CROSS-REFERENCE TO RELATED APPLICATIONS

This application claims the benefit of U.S. Provisional Application No. 60/762,680, filed Jan. 27, 2006. The disclosure of the above applications is incorporated herein by reference.

### FIELD OF THE INVENTION

The present invention relates to a shift restrictor apparatus for a transfer case.

### BACKGROUND OF THE INVENTION

This invention relates generally to the operation of two-speed transfer cases and more specifically to the shift from high to low range. It is known in the automobile industry that most vehicles that use either four-wheel-drive or all-wheel-drive systems are equipped with some sort of device for transferring power to the front wheels, usually this device is a transfer case, or something similar.

Current designs of the transfer case involve the use of a planetary gear set to obtain different gear ratios between the input shaft and output shaft of the transfer case. To change gear ratios, a shift system having a spring loaded shift device is used for completing delayed gear shifts once the input and output shafts are synchronized. Although the current spring loaded shift design is adequate, there exists a need for improvement of the design and advancement of the art. Current problems existing in the design include a “clunk” noise that can occur when the range shift is performed if the input and output shafts are not properly synchronized, resulting in a delay in the shift. The present invention will allow for a faster shift once the input and output shafts are synchronized to reduce any undesirable shift noise or delay.

### SUMMARY OF THE INVENTION

A shift fork restrictor operably disposed in a transfer case for the purpose of allowing the shift motor to transfer energy to the currently existing double wound spring, where the energy is stored until the shift motor sensor indicates that the motor is in the proper range location. When the motor is in the proper range location, the stored energy in the spring is released by the shift fork restrictor releasing the cam allowing for maximum torque and speed to be provided through the secondary rail, cam, and shift fork to complete the requested range shift. This configuration can be used to, among other things, select a high or low range in the transfer case, as well as couple the input and output shafts together, which have different gear ratios.

Another improvement to the current design that the present invention provides will be the use of sensors that can detect the position of the dog clutch. The dog clutch is the device that, depending upon its position along the output shaft, will provide either a direct drive, or a reduced speed gear ratio. Current designs of the transfer case use the position of a bidirectional motor, which is the device that controls the shift, to detect where the position of the dog clutch is located. Because of possible lag in the shift, the position of the bidirectional motor may not always give the correct position of the dog clutch. The use of sensors in the transfer case positioned in such a fashion to locate the exact position of the dog clutch will allow for the present invention to permit the shift to take place at the exact time necessary so no lag, or disturbing “clunk” noise, occurs.

Therefore, it is an object of this invention to provide an improved shift system in a transfer case.

It is a further object of this invention to provide a maximum speed shift from high to low range in the transfer case, and vise versa.

It is yet a further object of this invention to provide a shift fork restrictor that is adapted for use with a cam and shift fork assembly in a transfer case.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-section of a transfer case incorporating the present invention.

### DETAILED DESCRIPTION OF THE PREFERRED EMBODIMENTS

The following description of the preferred embodiment(s) is merely exemplary in nature and is in no way intended to limit the invention, its application, or uses.

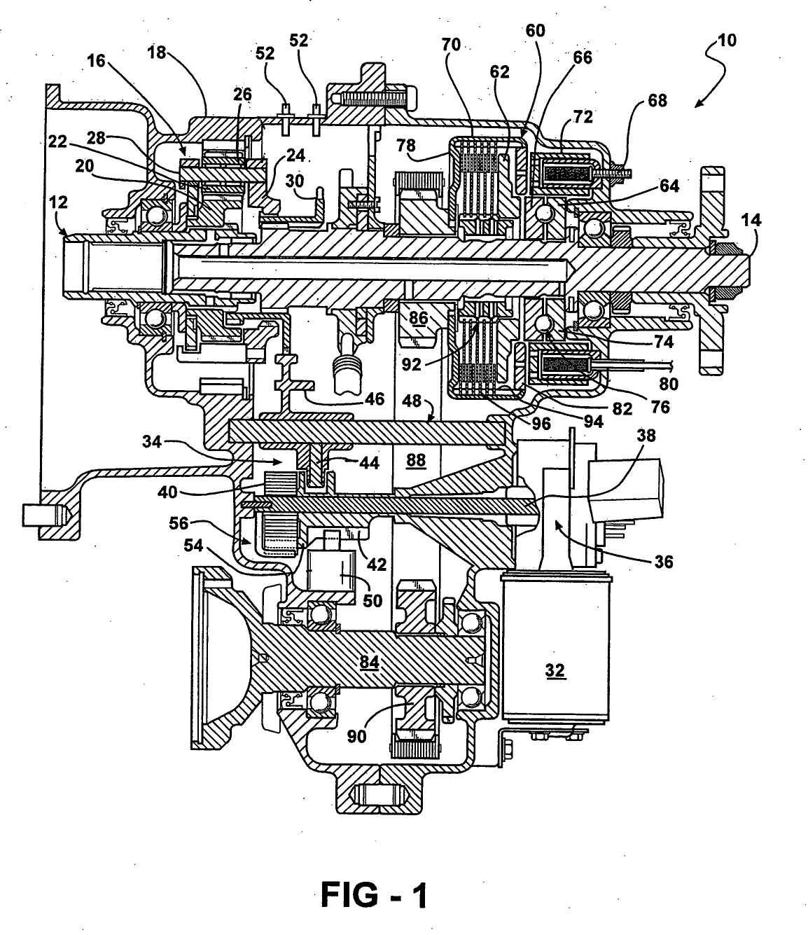

Referring to FIG. 1, a transfer case that has the present invention is shown at 10. The transfer case 10 includes a casing 18 which includes various supports, bearing surfaces, threaded openings, and other various features that serve the purpose of receiving other components of the transfer case. Among the other components is a gear reduction set 16 that is driven by the input shaft 12 and is coupled with the output shaft 14. The input shaft 12 has a plurality of teeth that are splined with the teeth on the internal surface of the sun gear 20. The sun gear 20 also has a plurality of teeth on its external surface that are in mesh with the planetary gears 22. The planetary gears 22 are rotatably received on stub shafts 28, which are mounted onto carrier 24. The ring gear 26 has a plurality of teeth that are directed inward and are in alignment with the sun gear 20. The planetary gears 22, in addition to being in mesh with the sun gear 20, are also in mesh with the ring gear 26. The carrier 24 has a plurality of teeth that are directed inwardly toward the dog clutch 30, and can selectively mate with a plurality of teeth on the external surface of the dog clutch 30. The dog clutch 30 also has a plurality of teeth that are splined to and is received about the output shaft 14. The dog clutch 30 rotates with the output shaft 14, but also may slide axially. The teeth on the internal surface of the dog clutch 30 are also complementary with the teeth on the input shaft 12.

The dog clutch 30 can be axially translated between three positions along the output shaft 14. The first is a forward position wherein the internal teeth of the dog clutch 30 are coupled with the teeth of the input shaft 12 and the output shaft 14, providing a direct or one-to-one ratio between the input shaft 12 and output shaft 14. In this position, the dog clutch 30 is not coupled to gear reduction set 16, therefore, gear reduction set 16 is not involved in transmitting torque through the transfer case 10. When the dog clutch 30 is axially translated into a position fully to the rear, the internal teeth of the carrier 24 are received upon the external teeth of the dog clutch 30, which is received about the output shaft 14. The input shaft 12 drives the sun gear 20, which is in mesh with the planetary gears 22. As the planetary gears 22 are driven by the sun gear 20, they also rotate the carrier 24, which in turn rotates the dog clutch 30, which then rotates the output shaft 14. This configuration causes the speed of the output shaft 14 to be reduced compared to the input shaft 12, normally at a ratio of 2:1 or 4:1. The third position of the dog clutch 30 is a neutral position, between the forward, or direct drive position, and the rearward, or reduced speed position. In this position, the input shaft 12 is not connected to the output shaft 14 in any fashion, and no power is transferred between them.

The location of the dog clutch 30 is controlled by a bidirectional motor 32 through the use of a worm gear assembly 36 and a shift fork and cam assembly 34. The shift fork and cam assembly 34 is made of several components, comprising of a drive shaft 38, a spring assembly 40 which is wrapped around the drive shaft 38, cylindrical cam 42, cam follower 44, shift fork 46, shift rail 48, and shift fork restrictor 50. The bidirectional motor 32 rotates drive shaft 38 through the worm gear assembly 36. The drive shaft 38 is supported in the casing 18 so that it may rotate freely when commanded to by the bidirectional motor 32. The spring assembly 40 couples the drive shaft 38 and the cam 42; the cam 42 is connected to the spring through an arm 54 that extends axially from the cam 42 into the spring assembly 40. The drive shaft 38 contains an arm 56 on the forward end that is also connected to the spring assembly 40. The spring assembly 40 acts as an elastic coupler between the drive shaft 38 and the cam 42, compensating for any lag when the bidirectional motor 32 is actuated, allowing the bidirectional motor 32 to reach its proper location. When a shift is requested, the internal teeth of the dog clutch 30 may not always be lined up with the teeth on the input shaft 12; conversely, the external teeth of the dog clutch 30 may also not been lined up with the inward teeth of the carrier 24. When the shift fork restrictor 50 is not engaged, it restricts movement of the cam 42. The drive shaft 38 is still allowed to rotate, and upon doing so, stores potential energy in the spring assembly. When the shift fork restrictor 50 is actuated, it releases the cam 42, thereby releasing the potential energy stored in the cam 42. The releasing of this energy allows for a maximum speed shift. Since the drive shaft 38 can be rotated in both directions, a faster shift can be achieved for shifting from low to high range, as well as high to low range. The cylindrical cam 42 defines a helical surface 58 that extends about the cam 42 approximately 270°. The cam follower 44 is received by the cam 42, and is coupled with, as well as axially translates the shift fork 46. The shift fork 46 is mounted to the shift rail 48, which is secured to the casing 18. The shift fork 46 engages the periphery of the dog clutch 30 and when the cam 42 rotates, the shift fork 46 is moved along the shift rail 48 axially and therefore locates the dog clutch 30 into one of the aforementioned positions.

Also included in the transfer case is an electromagnetic clutch assembly 60, comprising a circular drive member 66, a circular driven member 64, apply plate 62, an electromagnetic coil 68, and clutch pack 70. Circular driven member 64 can freely rotate about the output shaft 14, and is directly secured to rotor 72. The rotor 72 possesses a U-shaped cross-section that surrounds the magnetic coil 68 on three sides. Both the circular drive member 66, and the circular driven member 64 both include a plurality of opposed recesses 74, which receive load transferring balls 76. The opposed recesses 74 function as a ramp or cam that will push apart circular drive member 66, and circular driven member 64 when relative motion between them occurs. Circular drive member 66 and apply plate 62 are both splined to output shaft 14.

Upon activation of the electromagnetic coil 68, frictional contact occurs between surfaces 80 and 82. When the secondary output shaft 84 is rotating at a different speed than output shaft 14, frictional torque transfers load from the output shaft 14 through the circular drive member 66, through the load transferring balls 76, and through the circular driven member 64. This results in the load transferring balls 76 riding up in their respective recesses, displacing circular drive member 66 away from circular driven member 64 axially along the drive shaft 14. The circular drive member 66 then translates an apply plate 62 which in turn compresses clutch pack 70.

It should also be noted that those skilled in the are will recognized that activation of the clutch pack 70 can be accomplished by other means than through the use of electromagnetic coil 68. Clutch pack 70 could also be engaged through the use of hydraulic fluid, or pressurized air.

The clutch pack 70 is composed of a plurality of discs, interleaved with one another. The friction discs 96 are splined to the clutch hub 92, and the steel discs 94 are splined to the housing 78.

The clutch housing 78 is not splined to the output shaft 14, and can rotate freely. The housing 78 is coupled to drive sprocket 86, which is also free to rotate about the output shaft 14. Upon engagement of the clutch pack 70, torque from the output shaft 14 is transferred through the clutch hub 92, through the clutch pack 70, through the housing 78, through the drive sprocket 86, then through chain 88, through driven sprocket 90, and finally, through secondary output shaft 84.

It should be appreciated by those skilled in the art that the clutch pack 70 can be engaged by means other than the use of the electromagnetic coil 68. Hydraulic fluid or pressurized air could also be used to actuate the clutch pack, and produce the same result.

Also incorporated in the transfer case are two Hall Effect sensors 52. A first Hall Effect sensor 52 is disposed in proximate sensing relationship with collar of the dog clutch 30, when it is in the one-to-one, or direct-drive, position. A second Hall Effect sensor 52 is in proximate sensing relationship to the dog clutch 30 when it is in the reduced speed position. The Hall Effect sensors 52 directly locate the position of the dog clutch 30, which eliminates the need for detecting the position of the dog clutch 30 by use of the bidirectional motor 32.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A shift mechanism for a transfer case comprising:
a drive member having a bi-directionally rotating output;
a rotatable helical cam;
a shift fork having a cam follower operably associated with said helical cam;
an energy storing spring operably disposed between said rotating output of said drive assembly and said cam; and
a two-position solenoid, for selectively inhibiting and allowing motion of said rotatable helical cam.

2. The shift mechanism according to claim 1 wherein said energy absorbing spring is wound during rotation of said cam for storing energy when said actuator inhibits rotation of the helical cam.

3. The shift mechanism of claim 2 wherein the stored energy in the spring is released for facilitating a shaft rotation of said cam by said spring to the rotatable helical cam.

4. The shift mechanism of claim 1 wherein said rotatable helical cam is normally rotatable by said drive member through said

5. The shift mechanism of claim 4 wherein interference with the movement of said cam allows said spring to be wound by said drive mechanism for storing said energy.

6. The shift mechanism according to claim 1, wherein two Hall Effect sensors detect the position of said shift fork.

7. A method for performing a synchronized electronic shift in a two-speed transfer case, having an input shaft, and an output shaft, comprising the steps of:
providing for restriction of movement of a rotatable helical cam through the use of a solenoid;
providing for the use of a shift fork possessing a cam follower that is received by said rotatable helical cam;
providing for a drive member having a bi-directional rotating output;
providing for the storing of energy through the use of a spring assembly, which is operably disposed between and couples said drive member and said helical cam, and;
providing for two sensors that can detect the position of said shift fork.

8. The method of claim 7, wherein one method for said solenoid to restrict the movement of said helical cam is by use of a caliper, which grips said cam, therefore limiting its movement.

9. The method of claim 7, wherein another possible method for said solenoid restrict the movement of said rotatable helical cam, is to feature a stub shaft, in which said stub shaft engages a rib operably disposed about said rotatable helical cam.

10. The method of claim 7, wherein restriction of movement of said rotatable helical cam allows for storage of energy in said spring assembly, when said drive member rotates.

11. The method of claim 7, wherein upon engaging said solenoid, said cam is released, allowing for completion of the requested shift of said shift fork.

12. The method of claim 7, wherein said sensors are Hall Effect sensors.

13. A method of storing energy to be used for performing high-speed shifts in a transfer case comprising the steps of:
storing energy in a spring assembly, and;
selectively restricting the motion of a helical cam by use of a solenoid, upon release of which performs requested shift.

14. The method of storing energy in claim 13, where in said method includes a drive member upon rotation of which, stores energy in said spring assembly, and is capable of rotating in two directions.

15. The method of storing energy in claim 13, wherein said helical cam features a cam surface located 270° about the cam.

16. The method of storing energy in claim 13, wherein a shift fork including a cam follower is capable of being received by said cam.

17. The method of storing energy in claim 13, wherein said spring assembly, capable of storing energy, is located for operation between and couples said output drive member and said cam.

18. The method of storing energy in claim 13, wherein a device, when located in one of two positions, capable of permitting or restricting motion of said helical cam.

19. The device of claim 18, wherein said device can feature either a caliper or a stub shaft for engaging said helical cam for restricting movement.

20. The method of storing energy in claim 13, wherein the position of said helical cam is detected by Hall Effect sensors.
